(19) United States
(12) Patent Application Publication
(10) Pub. No.: US 2020/0079109 A1
(43) Pub. Date: Mar. 12, 2020

(54) IMAGE FORMING APPARATUS

(71) Applicants: Masashi OTA, Kanagawa (JP); Tomoya FUJII, Kanagawa (JP); Munekazu HIRATA, Tokyo (JP); Satoshi NARAI, Kanagawa (JP); Kunihiko NISHIOKA, Kanagawa (JP); Yohei OSANAI, Kanagawa (JP); Takayuki ANDOH, Kanagawa (JP); Masatoshi ISHIDA, Kanagawa (JP)

(72) Inventors: Masashi OTA, Kanagawa (JP); Tomoya FUJII, Kanagawa (JP); Munekazu HIRATA, Tokyo (JP); Satoshi NARAI, Kanagawa (JP); Kunihiko NISHIOKA, Kanagawa (JP); Yohei OSANAI, Kanagawa (JP); Takayuki ANDOH, Kanagawa (JP); Masatoshi ISHIDA, Kanagawa (JP)

(73) Assignee: Ricoh Company, Ltd., Tokyo (JP)

(21) Appl. No.: 16/451,424

(22) Filed: Jun. 25, 2019

(30) Foreign Application Priority Data
Sep. 10, 2018 (JP) 2018-169097

(51) Int. Cl. B41J 3/36

(52) U.S. Cl. CPC B41J 3/36

(57) ABSTRACT

An image forming apparatus includes a body including a recording side to be disposed opposite a recording medium and an operation face opposite the recording side. The image forming apparatus further include an image forming device supported on the recording side and configured to form an image on the recording medium, an operation input device configured to input an image formation instruction, and a power operation device configured to power on and off the image forming apparatus. On the operation face, the operation input device is disposed at a first position shifted from a center position on the operation face in a predetermined direction, and the power operation device is disposed at a second position located on an opposite side of the first position with respect to the center position on the operation face.

### CROSS-REFERENCE TO RELATED APPLICATION

This patent application is based on and claims priority pursuant to 35 U.S.C. 119(a) to Japanese Patent Application No. 2018-169097, filed on Sep. 10, 2018, in the Japan Patent Office, the entire disclosure of which is hereby incorporated by reference herein.

### BACKGROUND

### Technical Field

This disclosure relates to an image forming apparatus.

### Description of the Related Art

Mobile image forming apparatuses, such as mobile inkjet printers, include a power button (or a power switch) and an operation button (e.g., a print start button) for image formation. In some image forming apparatuses, the power switch and the operation button are disposed on a side opposite a recording side of the image forming apparatus opposed to a recording medium.

For example, a user holds, with one hand, a body of the mobile inkjet printer (hereinafter “printer body”) to move the mobile inkjet printer on the recording medium in order to form an image thereon. For example, the user turns on or off the power button (a power operation device) disposed on the upper side (an operation side) of the printer body to power on or off the printer and presses the print start button (an operation input device) disposed on the upper side of the printer body to start image formation.

### SUMMARY

According to an embodiment of this disclosure, an image forming apparatus includes a body including a recording side to be disposed opposite a recording medium and an operation face opposite the recording side. On the operation face, an operation input device configured to input an image formation instruction and a power operation device configured to power on and off the image forming apparatus are disposed. The image forming apparatus further includes an image forming device supported on the recording side and configured to form an image on the recording medium. On the operation face, the operation input device is disposed at a first position shifted from a center position on the operation face in a predetermined direction, and power operation device is disposed at a second position located on an opposite side of the first position with respect to the center position on the operation face.

According to another embodiment, an image forming apparatus includes a body including a recording side to be disposed opposite a recording medium and an operation face opposite the recording side. On the operation face, a power operation device configured to power on and off the image forming apparatus and an operation input device configured to input an image formation instruction are disposed. The image forming apparatus further includes circuitry configured to provide a prohibition period in a period from a start of an image forming operation to an end of the image forming operation, the prohibition period in which the circuitry prohibits powering off the image forming apparatus in response to an operation of the power operation device.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exterior perspective view illustrating a handheld printer as viewed from obliquely upward angle according to Embodiment 1;

FIG. 2 is an exterior perspective view of a printer body in a state in which a cover is removed from the printer body;

FIG. 3 is an exterior perspective view of the printer body in a state in which a spacer is detached, as viewed obliquely from below;

FIG. 4 is a perspective view of the printer body in a state in which a printed image is being formed on a recording medium;

FIG. 5 is a block diagram illustrating a part of an electric circuit of the printer body;

FIG. 6 is an external perspective view of the printer body in a state in which the spacer is attached, viewed obliquely from below;

FIG. 7 is a schematic view illustrating the printer body being moved along a curved track in a roller contactless state;

FIG. 8 is a schematic view illustrating a user holding the printer body with one hand when using the printer body;

FIG. 9 is a flowchart illustrating a flow of control of operation of a power button according to Embodiment 2; and

FIG. 10 is a plan view illustrating another long shape of an operation face of the printer body.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

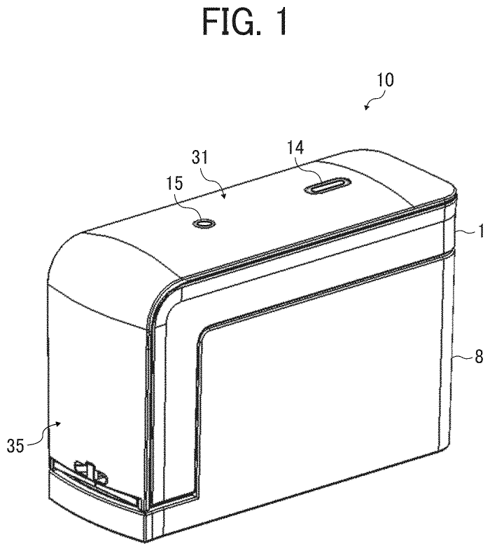

Referring now to the drawings, wherein like reference numerals designate identical or corresponding parts throughout the several views thereof, and particularly to FIG. 1, an image forming apparatus according to an embodiment of this disclosure is described. As used herein, the singular forms “a”, “an”, and “the” are intended to include the plural forms as well, unless the context clearly indicates otherwise.

### Embodiment 1

In the present embodiment, aspects of the present disclosure are applied to a handheld inkjet printer which is a mobile image forming apparatus (hereinafter referred to as “Embodiment 1”).

First, a basic configuration of a printer body of the handheld printer according to Embodiment 1 is described.

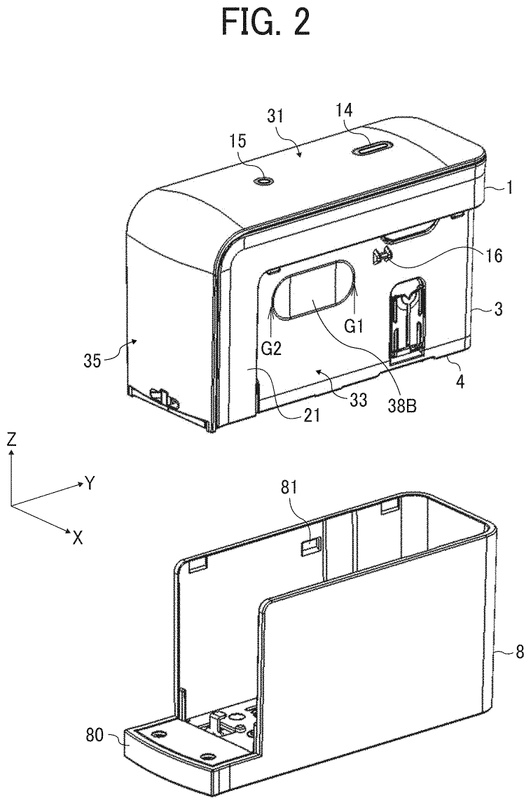

FIG. 1 is an external perspective view illustrating a handheld printer 10 according to the embodiment 1, as viewed from obliquely upward. FIG. 2 is an external perspective view of the printer body 1 in which a cover 8 is removed from the printer body 1. The printer body 1 is the apparatus body of the handheld printer 10.

The handheld printer 10, according to the present embodiment, includes the printer body 1, a spacer 4 removably attached to the printer body 1, and the cover 8, which is attached to the printer body 1 with the spacer 4 housed in the cover 8. The cover 8 is made of resin such as acrylonitrile butadiene styrene (ABS) resin, and recesses 81 are formed on the inner wall surface thereof. When the cover 8 is attached to the printer body 1, two projections 16 (one of the two is illustrated in FIG. 2) provided on the printer body 1 are respectively hooked to two recesses 81 (one of the two is illustrated in FIG. 2) provided on the cover 8 by snap-fit. Thereby, the state in which the cover 8 is attached to the printer body 1 is held. When removing the cover 8 from the printer body 1, the user pulls the printer body 1 out of the cover 8 so that the projections 16 caught by the snap-fit are removed from the recesses 81 and the user can remove the cover 8 from the printer body 1.

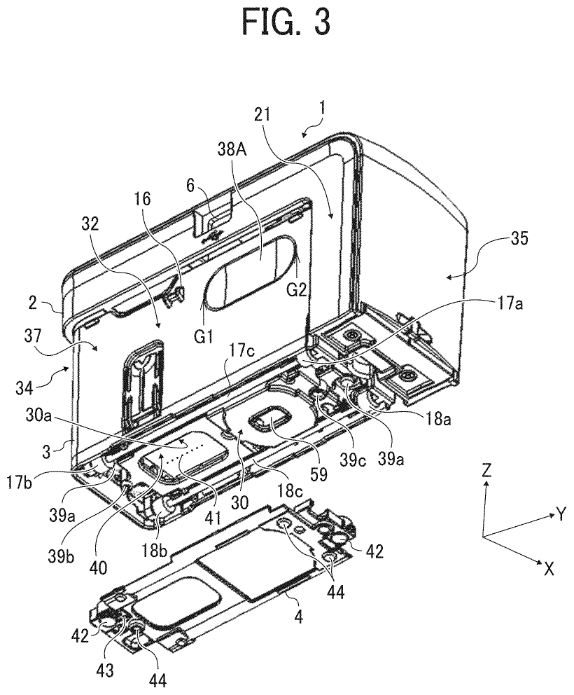

FIG. 3 is an exterior perspective view of the printer body 1 and the spacer 4 detached from the printer body 1, as viewed obliquely from below.

The printer body 1 illustrated in FIG. 3 includes an upper unit 2 and a lower unit 3. The printer body 1 as a whole is shaped like a rectangular parallelepiped. In a scanning direction, that is, a printing direction indicated by arrow X in FIG. 1 (X-axis direction), the printer body 1 has such a length that a user can grasp the printer body 1 with a palm.

The housing of the printer body 1 includes a recording side 30 on which a recording portion (image forming device) of the inkjet head (described later) is disposed opposed to a recording medium such as a paper sheet, an upper side 31 opposite the recording side 30, a left side 32 extending in a direction orthogonal (indicated by arrow y, hereinafter referred to as “scanning orthogonal direction”) to scanning direction (indicated by arrow x). The housing further includes, for example, a right side 33 extending in the direction orthogonal to the scanning direction, a rear side 34 extending in the scanning direction (indicated by arrow x), and a front side 35 extending in the scanning direction. The printer body 1 is usually used in such a posture that the recording side 30 is faced vertically down and the upper side 31, which is opposite the recording side 30, is faced vertical up.

A print button 14 as an operation input device and a power button 15 as a power operation device are disposed on the upper side 31. The left side 32 of the upper unit 2 includes a universal serial bus (USB) connection port 6. The USB connection port 6 is a port for connecting a USB cable. The printer body 1 is provided with a rechargeable battery mounted therein. The rechargeable battery can be charged when electric power is supplied thereto from an external power supply via the USB cable connected to the USB connection port 6.

A wide portion 21 of the upper unit 2 connects to the front side 35 of the lower unit 3. The wide portion 21 has a wider width than a narrow portion 37 of the lower unit 3. On the left and right sides 32 and 33 of the narrow portion 37 of the lower unit 3, finger-grip portions 38A and 38B are formed at the positions where the user applies the fingers (usually the thumb and one of the middle finger, the ring finger, and the little finger) of the hand, respectively, while gripping and using the printer body 1. When the user moves the printer body 1 on a surface of the recording medium in the scanning direction (X-axis direction) for image formation, the user holds the finger-grip portions 38A and 38B on the left and right sides 32 and 33, positioning the wide portion 21 closer to the wrist, to sandwich the lower unit 3 with the fingers to hold the printer body 1.

The finger-grip portions 38A and 38B are recesses, for example. However, the shape can be a projection or a rugged shape depending on the property of the cover 8. Each of the finger-grip portions 38A and 38B can have any shape as long as the following conditions are satisfied. The shape represents a portion where a finger is put, the finger put thereon is caught thereby, and slip of the finger thereon is inhibited.

The wide portion 21 is made wider than the narrow portion 37 in the scanning orthogonal direction so that the outer wall surface of the wide portion 21 and the outer wall surface of the cover 8 are on substantially identical plane, when the cover 8 is attached to the printer body 1, as illustrated in FIG. 1.

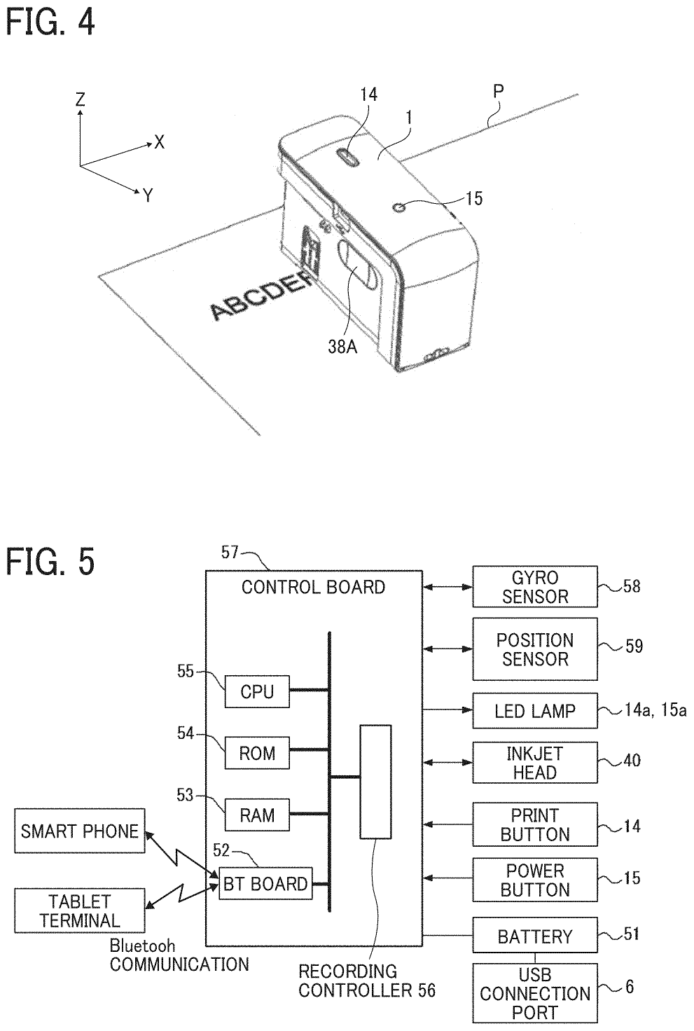

The user can switch on and off the power of the printer body 1 by holding down the power button 15. As described above, a structure that power is turned off by pressing the power button 15 for a while can suppress the erroneous operation of the power button 15 during the image forming operation. When the power is turned on, the control board provided in the upper unit 2 of the printer body 1 can acquire image data by wireless communication with a smartphone or the like. After the user places the printer body 1 on the surface of a recording medium P with the recording side 30 facing the surface of the recording medium P, the user presses the print button 14 once and moves the printer body 1 in the scanning direction as illustrated in FIG. 4 (in direction X), thus forming an image on the recording medium P. The printer body 1 can form an image on the surface of the recording medium in both of forward movement and backward movement in the scanning direction (manual scanning) when the user moves the printer body 1 back and forth.

The recording medium P is not limited to paper, such as paper sheets, but includes any other image formation targets, for example, overhead projector (OHP) sheets, cloth, cardboards, packaging containers, glass, and substrates.

The upper unit 2 is held by the lower unit 3 to open and close with respect to the lower unit 3. The inkjet head 40, the ink cartridge which includes the recording portion and the ink tank combined into a single unit, is mounted inside the lower unit 3. At this time, the recording section to discharge ink droplets is faced down in the vertical direction. The inkjet head 40 discharges ink droplets from the recording portion to record an image on a recording medium.

As illustrated in FIG. 3, the recording side 30 of the printer body 1 includes an opening 30a to expose the recording portion of the inkjet head 40 mounted in the lower unit 3 to the outside. The recording portion of the inkjet head 40 includes a plurality of discharge nozzles 41 and is capable of discharging ink droplets separately from the respective discharge nozzles 41 as piezoelectric elements are driven.

As a driving source to discharge ink, the inkjet head 40 employs, for example, electromechanical transducer elements (piezoelectric actuators) including lamination-type piezoelectric elements or thin-film-type piezoelectric elements, or electrostatic actuators including electrothermal transducer elements, such as heat elements, made of diaphragms and opposed electrodes.

The “ink (liquid)” discharged from the discharge nozzles 41 of the recording portion is not particularly limited as long as the liquid has a viscosity and a surface tension that enable discharge from the discharge nozzles 41. However, it is preferable that the viscosity is 30 mPa·s or less under ordinary temperature and pressure or by heating or cooling. Specifically, the term “liquid” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, surface treatment liquid, a liquid for forming components of electronic element or light-emitting element or a resist pattern of electronic circuit, or a material solution for three-dimensional fabrication.

Inside the outer edge of the recording side 30, a position sensor 59 as a detector to detect the position of the printer body 1 on the recording medium, a rotatable first left roller 17a, a second left roller 17b, a first right roller 18a, and a second right roller 18b are disposed.

When the user moves the printer body 1 in the scanning direction, the four rollers contacting the surface of the recording medium P rotate like tires. Owing to such rollers, the user can move forward or backward the printer body 1 straight in the scanning direction. At this time, only the four rollers of the printer body 1 are in contact with the surface of the recording medium and keep the distance between the recording side 30 and the surface of the recording medium at a predetermined separation distance. Therefore, a constant distance can be maintained between the recording portion of the inkjet head 40 and the surface of the recording medium, thus forming a desired high-quality image.

The position sensor 59 is a sensor to detect the distance to the surface of the recording medium, the surface state (for example, asperities) of the recording medium, and the distance by which the printer body 1 has traveled. The position sensor 59 is similar to a sensor used for, for example, an optical mouse (a pointing device) of a personal computer. The position sensor 59 irradiates, with light, a place (recording medium) where the printer body 1 is placed and reads the state of the place as a “pattern”. The position sensor 59 sequentially detects how the “pattern” moves relative to the movement of the position sensor 59, to calculate the amount of movement.

FIG. 5 is a block diagram illustrating a portion of an electric circuit of the printer body 1.

A control board 57 includes a central processing unit (CPU) 55 that performs various arithmetic processing and program execution, a Bluetooth (BT, registered trademark) board 52 for short-range wireless communication, a random access memory (RAM) 53 that temporarily stores data, a read-only memory (ROM) 54, and a recording controller 56. The control board 57 is secured at a position on the back side of the USB connection port 6 in a hollow space of the upper unit 2.

The BT board 52 performs data communication by short-range wireless communication (Bluetooth communication) with an external device, such as a smartphone or a tablet terminal. The ROM 54 stores, for example, firmware for hardware control of the printer body 1 and drive waveform data of the inkjet head 40. The recording controller 56 executes data processing for driving the inkjet head 40 and generates drive waveforms.

The control board 57 is electrically connected to a gyro sensor 58, the position sensor 59, LED lamps 14a and 15a, the inkjet head 40, the print button 14, the power button 15, the battery 51, and the like.

The gyro sensor 58 detects the tilt and rotation angle of the printer body 1 and transmits the detection result to the control board 57. The LED lamp 14a is disposed inside an exterior cover made of a light transmissive material of the print button 14 and makes the print button 14 luminous. Similarly, the LED lamp 15a is disposed inside an exterior cover made of a light transmissive material of the power button 15 and makes the power button 15 luminous.

When the power button 15 is pressed to turn on the power of the printer body 1, power is supplied to each module. The CPU 55 initiates startup according to the program stored in the ROM 54 and loads the program and each data in the RAM 53. When data of an image to be formed is received from an external device by short-range wireless communication, the recording controller 56 generates a drive waveform corresponding to the image data. Then, the discharge of ink from the inkjet head 40 is controlled to form an image corresponding to the position on the surface of the recording medium detected by the position sensor 59.

In response to acquisition of image data via short-range wireless communication from an external device, the control board 57 causes the LED lamp 14a to blink so that the print button 14, which transmits light, becomes luminous and blinks. Seeing such blinking, the user knows that the image data is being acquired by the printer body 1. The control board 57 causes the LED lamp 14a to keep emitting light when acquisition of image data is completed and the image forming operation is feasible. Seeing such light emission, the user knows that the image forming operation is feasible. Then, the user places the printer body 1 on the recording medium and presses the print button 14.

Meanwhile, as the control board 57 starts blinking of the LED lamp 14a, the control board 57 waits for pressing of the print button 14. When the print button 14 is pressed, the control board 57 causes the LED lamp 14a to blink so that the print button 14 becomes luminous and blinks. Seeing such blinking, the user knows that printer body 1 is in image forming operation and starts moving (manual scanning) the printer body 1 in the scanning direction.

Finishing moving (manual scanning) of the printer body 1, the user presses the print button 14 again. With such an operation, the control board 57 turns off the LED lamp 14a and stops lighting of the print button 14. Or, there may be a case where the user does not press the print button 14 and picks up the printer body 1 from the recording medium and places the printer body 1 such as on a table or places the printer body 1 onto the cover 8. In this case, at the timing the user picks up the printer body 1 from the recording medium, the position sensor 59 no longer detects the position. At the timing when the position sensor 59 no longer detects the position, the control board 57 turns off the LED lamp 14a and stops lighting of the print button 14.

It is not necessary to keep pushing the print button 14 while the user moves (manual scanning) the printer body 1. Once the print button 14 is pushed and released before the moving of the printer body 1, the image forming operation based on the detection result by the position sensor 59 is continued until the end of the image formation, the print button 14 is pushed again, or the end of the position detection by the position sensor 59.

The printer body 1 includes a left roller unit 17 and a right roller unit 18. The left roller unit 17 is attached to an end on the side of the left side 32 in the scanning direction (indicated by arrow X) of the printer body 1. The right roller unit 18 is attached to an end on the side of the right side 33 in the scanning direction of the printer body 1.

The left roller unit 17 includes a metal shaft 17c, the first left roller 17a secured to one end side in the longitudinal direction of the shaft 17c, and the second left roller 17b secured to the other end side of the shaft 17c. Each of the first left roller 17a and the second left roller 17b is made of a material, such as rubber, having a relatively large frictional resistance.

The right roller unit 18 includes a metal shaft 18c, the first right roller 18a secured to one end side in the longitudinal direction of the shaft 18c, and the second right roller 18b secured to the other end side of the shaft 18c. Each of the first right roller 18a and the second right roller 18b is made of a material, such as rubber, having a relatively large frictional resistance.

As the both of two end portions of the shaft 17c in the longitudinal direction are fitted in sliding bearings fixed to the printer body 1, the left roller unit 17 is rotatably held by the sliding bearings. Similar to the left roller unit 17, the right roller unit 18 is rotatably held by sliding bearings 72 fixed to the printer body 1.

The left roller unit 17 and the right roller unit 18 are for enhancing the straight traveling performance of the printer body 1 in the scanning direction (indicated by arrow X). While the first left roller 17a and the second left roller 17b secured to the shaft 17c rotate together as one unit, the first right roller 18a and the second right roller 18b secured to the shaft 18c rotate together as one unit, thus improving the straight traveling performance.

In the printer body 1 according to the present embodiment 1, the two rollers 17a and 17b of the left roller unit 17 and the two rollers 18a and 18b of the right roller unit 18 are disposed at positions deviating from the recording portion in the orthogonal direction (indicated by arrow Y) to the scanning direction. In such an arrangement, when the printer body 1 is moved, the rollers 17a, 17b, 18a, and 18b are inhibited from contacting an image portion immediately after formed. Therefore, the image can be protected from being disturbed by the rollers 17a, 17b, 18a, and 18b contacting the image portion.

As described above, the shafts 17c and 18c as rotation shafts of the roller units 17 and 18 are made of metal. Compared with a structure using a nonmetallic shaft, use of the metal shaft is advantageous in suppressing bend of the shaft during moving of the printer body 1, thereby inhibiting the image from being disturbed by unstable traveling of the printer body 1 due to the flexure of the shaft. Further, the printer body 1 can be compact when a shaft having a small diameter is used.

Here, in the configuration provided with the rollers 17a, 17b, 18a and 18b like the printer body 1 of Embodiment 1, as described above, when the user moves the printer body 1 in the scanning direction (manual scanning), the straight traveling performance is secured. However, the rollers 17a, 17b, 18a and 18b inhibit smooth traveling when the printer body 1 is moved along a curved track, thus inhibit smooth manual scanning.

In addition, when recording on the second line is performed after recording on the first line, a line feed operation is required to move the printer body 1 in the scanning orthogonal direction with the recording side 30 kept facing the surface of the recording medium so that position detection by the position sensor 59 is not disabled. Also in this line feed operation, the rollers 17a, 17b, 18a, and 18b of the printer body 1 inhibits the movement in the scanning orthogonal direction and become a hindrance to a smooth line feed operation.

Therefore, the handheld printer 10 of the present embodiment is provided with the spacer 4 which is attachable to and detachable from the recording side 30 of the printer body 1, and the usage form of the handheld printer 10 can be switched by attaching and detaching the spacer 4. Specifically, the usage form can be switched between a roller contact state in which scanning is performed while the rollers 17a, 17b, 18a and 18b are in contact with the surface of the table on which the recording medium P is placed or the surface of the recording medium P and roll, and a roller contactless state in which the rollers 17a, 17b, 18a and 18b are not in contact with the surface of the table on which the recording medium P is placed or the surface of the recording medium P.

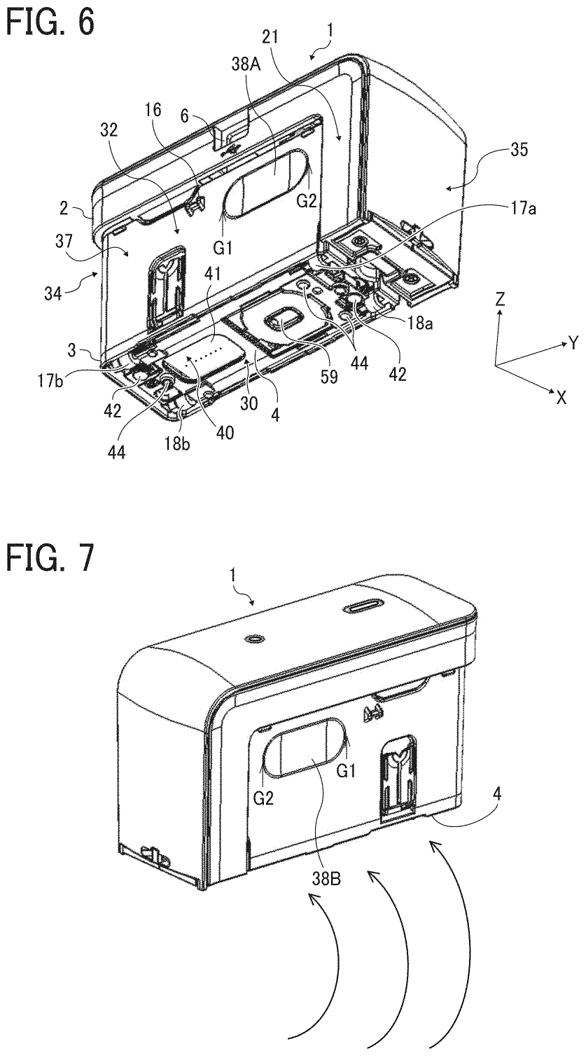

FIG. 6 is an exterior perspective view of the printer body 1 in a state in which the spacer 4 is attached, as viewed obliquely from below.

When the spacer 4 is detached from the printer body 1, the handheld printer 10 can be used in the roller contact state in which the printer body 1 is moved for scanning with the rollers 17a, 17b, 18a, and 18b of the printer body 1 in contact with and rolling on the surface of the recording medium P as illustrated in FIG. 3. As a result, owing to straight traveling performance of the rollers 17a, 17b, 18a and 18b, the user can easily move the printer body 1 straight along the scanning direction and can form an appropriate image. On the other hand, when the spacer 4 is detached from the recording side 30 of the printer body 1, the handheld printer 10 can be used in the roller contactless state in which the printer body 1 is moved for scanning with the rollers 17a, 17b, 18a, and 18b of the printer body 1 contactless with the surface of the recording medium P and the like as illustrated in FIG. 6.

The spacer 4 is attached to and detached from the recording side 30 of the lower unit 3 with magnets. Specifically, the spacer 4 includes magnets 42, and screw heads 39a of metal screws as fastening members that are two magnetic bodies are exposed to the recording side 30. The magnets 42 are disposed to oppose the screw heads 39a when the spacer 4 is attached to the recording side 30 of the printer body 1. In the present embodiment 1, the magnetic body provided on the spacer 4 is described as an example of a fastening member such as a metal screw but may be a frame member such as a metal frame of the spacer 4. Such a frame member is usually made of metal in order to secure rigidity and can be used as a magnetic body.

Further, as illustrated in FIG. 3, in order to align the recording side 30 of the lower unit 3 with the spacer 4, an alignment projection 39b and an alignment hole 39c are formed on the recording side 30. On the spacer 4, an alignment hole 43 where the alignment projection 39b fits and an alignment projection which fits in the alignment hole 39c are formed at respective corresponding positions. When the spacer 4 is properly aligned with the recording side 30 such that the alignment projection and the alignment hole fit in and around the alignment hole and alignment projection on the other side, the magnets 42 on the spacer 4 face the screw heads 39a of the recording side 30. Then, as illustrated in FIG. 6, the spacer 4 is mounted and held onto the recording side 30 by the magnetic force of the magnets 42.

The body of the spacer 4 is made of resin such as ABS resin. Three projections 44 to support the printer body 1 are provided on the recording medium opposing surface of the spacer 4 (surface opposite to the side facing the recording side 30 at the time of mounting). The tips of the projections 44 of the spacer 4 mounted on the recording side 30 of the printer body 1 are farther from the recording side 30 than the rollers 17a, 17b, 18a, and 18b in the direction in which the recording side faces the recording medium P. Therefore, when the printer body 1 to which the spacer 4 is attached is placed on the recording medium P, the tips of the projections 44 contact the recording side 30 to float the rollers 17a, 17b, 18a, and 18b from the surface of the recording medium P. As a result, the handheld printer 10 is in a roller contactless state.

To use the handheld printer 10 in the roller contactless state, the user holds the printer body 1 and places the printer body 1 on the recording medium P so that the recording side 30 to which the spacer 4 is attached opposes the surface of the recording medium P. At this time, the printer body 1 is supported at three points by the projections 44 of the spacer 4 so that the rollers 17a, 17b, 18a, and 18b float from the surface of the recording medium P. Then, the user moves the printer body 1 (manual scanning) so that the three projections 44 slide on the surface of the recording medium P, and can form an image on the recording medium P.

FIG. 7 is a perspective view illustrating the printer body 1 being moved along a curved track in the roller contactless state.

In the roller contactless state, since the rollers 17a, 17b, 18a, and 18b float from the surface of the recording medium P, an operation of moving the printer body 1 (manual operation) in a direction different from the scanning direction (X-axis direction) is not disturbed by the rollers 17a, 17b, 18a, and 18b. Therefore, the curved traveling performance of the printer body 1 is improved compared to the roller contact state. As a result, the printer body 1 can be easily moved along the curved track.

In addition, when recording on the second line is performed after recording on the first line in the scanning direction, and a line feed operation to move the printer body 1 in the scanning orthogonal direction with the recording side 30 facing the surface of the recording medium is not disturbed by the rollers 17a, 17b, 18a, and 18b. Therefore, the operability of the line feed operation is improved compared to the roller contact state. In the roller contactless state, since the straight traveling performance by the rollers 17a, 17b, 18a, and 18b is not feasible, the user needs to move the printer body 1 straight in the scanning direction without assistance from the rollers 17a, 17b, 18a, and 18b.

According to Embodiment 1, each of the three projections 44 of the spacer 4 is disposed out of the range of the recording portion (where the plurality of discharge nozzles 41 are located) of the inkjet head 40 in the direction (Y-axis direction) orthogonal to the scanning direction. Thus, the image can be protected from being disturbed by the projections 44 rubbing against the image portion immediately after formed during image formation in the roller contactless state.

Next, descriptions are given below of arrangement of the print button 14 and the power button 15 on the upper side 31 of the printer body 1 according to Embodiment 1.

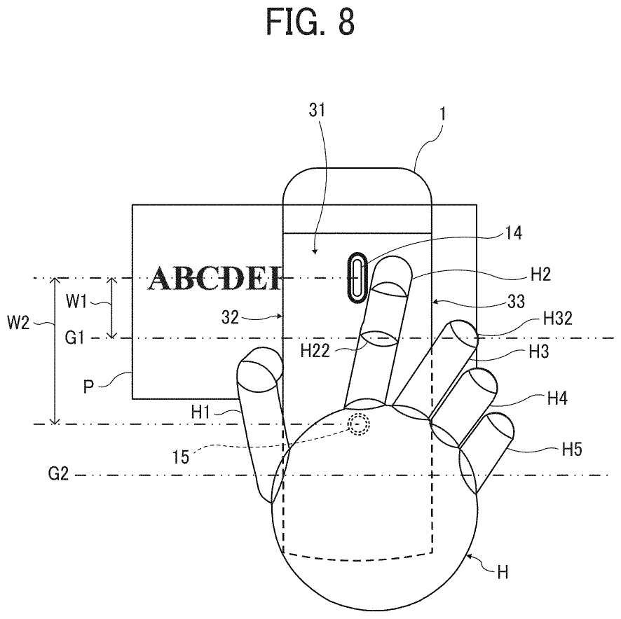

FIG. 8 is a view illustrating a hand of the user holding the printer body 1 when the user uses the handheld printer 10.

When the user uses the handheld printer 10, as illustrated in FIG. 8, the user holds the printer body 1 in a posture to be able to operate the print button 14, on the upper side 31 of the printer body 1, with his or her forefinger H2 (or middle finger H3). Such a posture is hereinafter referred to as a regular posture of the user. At this time, the user places the thumb on the first finger-grip portion 38A as a first finger rest portion on the left side 32 and places the middle finger H3 or the ring finger H4 (or the little finger H5) on the second finger-grip portion 38B as a second finger rest portion on the right side 33. Then, the user holds the printer body 1 so that the fingers respectively placed on the first and second finger-grip portions 38A and 38B sandwich the lower unit 3.

At this time, there is an inconvenience if the power button 15, disposed similar to the print button 14 on the upper side 31, is in the vicinity of the print button 14, more specifically, the power button 15 is disposed, similar to the print button 14, in a range accessible by the forefinger H2 (or the middle finger H3) of the user in the regular posture. That is, there is a risk that the finger of the user (in particular, the forefinger H2 or the middle finger H3) touches the power button 15 during the image forming operation. In this case, the user may accidentally turn off the power of the printer body 1 in mid course the image forming operation and unintentionally terminate the image forming operation.

Therefore, in Embodiment 1, as illustrated in FIG. 8, the print button 14 is disposed at a first position shifted (shifted upward in FIG. 8) from a center on the upper side 31 being an operation face on which the user operates the buttons, and the power button 15 disposed at a second position shifted (downward in FIG. 8) to the opposite side of the first position. In particular, in Embodiment 1, since the upper side 31 of the printer body 1 is long in the vertical direction in the drawing, the print button 14 is on one side in the longitudinal direction of the upper side 31 (upper end in FIG. 8) and the power button 15 is disposed on the other side in the longitudinal direction of the upper side 31 (lower side in FIG. 8).

When the user moves the printer body 1 according to Embodiment 1, gripping the printer body 1 in the regular posture as illustrated in FIG. 8, the user prefers moving the printer body 1 (manual scanning) in the horizontal direction in FIG. 8 (X-axis direction in FIG. 4) to moving the printer body 1 in the vertical direction in FIG. 8 (Y-axis direction in FIG. 4). In this case, the print button 14 is disposed on one side (upper end in the figure) of the upper side 31 in the orthogonal direction (Y-axis direction) orthogonal to the scanning direction (X-axis direction) at the time of image formation, and the power button 15 is disposed on the other side (lower side in the drawing) of the upper side 31 in the orthogonal direction (Y-axis direction).

Further, as described above, the printer body 1 of Embodiment 1 includes the first finger-grip portion 38A, on the left side 32, to be held by the thumb H1 of the hand of the user and the second finger-grip portion 38B, on the right side 33, to be held by the middle finger H3, the ring finger H4, or the little finger H5 of the hand of the user when the user grips the printer body 1 in the regular posture as illustrated in FIG. 8. Although the description above concerns the user holding the printer body 1 with his or her right hand, the printer body 1 can be held with a left hand. In this case, the second finger-grip portion 38B serves as the first finger rest portion held by a left hand thumb, and the first finger-grip portion 38A serves as the second finger rest portion held by a left hand finger other than the thumb. Relative positions between the first and second finger-grip portions 38A and 38B and the print button 14 and the power button 15 are as follows. Referring to FIGS. 6 to 8, the print button 14 is on the fingertip side of the upper side 31 than the fingertip side end G1 of the first finger-grip portion 38A (or the second finger-grip portion 38B), and the power button 15 is on the wrist side of the upper side 31 than the fingertip side end G1. The power button 15 is preferably disposed on the fingertip side end of the upper side 31 than the wrist side end G2 of the first finger-grip portion 38A (or the second finger-grip portion 38B).

Specifically, the print button 14 is disposed such that, in the vertical direction in FIG. 8 (the orthogonal direction indicated by arrow Y in FIG. 6), a distance W1 between a center position of the print button 14 and the fingertip side end G1 of the first finger-grip portion 38A or the second finger-grip portion 38B is equal to or greater than 30 mm, preferably equal to or greater than 35 mm, and more preferably equal to or greater than 45 mm. In this configuration, the power button 15 is preferably disposed such that a distance W2 between a center position of the print button 14 and the center position of the power button 15 is equal to or greater than 45 mm in the vertical direction in FIG. 8 (the orthogonal direction indicated by arrow Y).

In the arrangement according to Embodiment 1, when the user holds the printer body 1 in the regular posture to operate the print button 14 with the forefinger H2 (or the middle finger H3), as illustrated in FIG. 8, the power button 15 is located closer to the wrist side end than the area accessed by the finger of the hand (in particular, the forefinger H2 or the middle finger H3 that may be rested on the upper side 31). Such a position of the power button 15 is approximately falls in a wrist-side region of the upper side 31 facing a portion of the hand of the user closer to the wrist than a second joint H22 of the forefinger H2 or a second joint H32 of the middle finger H3 when the user holds the printer body 1 with one hand in the regular posture in which the print button 14 can be operated with the forefinger H2 or the middle finger H3. As long as the power button 15 is in such an area, normally, the forefinger H2 or the middle finger H3 of the hand gripping the handheld printer 10 does not touch the power button 15, and the user does not erroneously operate the power button 15 with the finger during the image forming operation. Accordingly, this configuration can inhibit an accidental termination of the image forming operation.

Note that,

In particular, in the present embodiment, the dimensions of the power button 15 are set smaller than the dimensions of the print button 14. In this configuration, for the user, touching the power button 15 is less easy than touching the print button 14, and erroneous operation of the power button 15 during the image forming operation can be inhibited.

Here, in the present embodiment, in order to simplify the printer body 1, components to make the user visually recognize the status of the handheld printer 10 are limited to the LED lamps 14a and 15a of the print button 14 and the power button 15. However, when the user holds the printer body 1 in the regular posture, the power button 15 on the upper side 31 is hidden by the palm of the user not to be visually recognized. Therefore, preferably, the handheld printer 10 is configured to indicate information notified from the printer body 1 to the user using the LED lamp 14a of the print button 14 when the user holds the printer body 1.

Specifically, for notification of information that acquisition of image data is ongoing by short-range wireless communication from an external device, for example, the control board 57 blinks the LED lamp 14a of the print button 14 in blue while acquiring the image data.

Further, for notification of information that the handheld printer 10 is ready for an image forming operation, for example, the control board 57 causes the LED lamp 14a of the print button 14 to keep emitting blue light when acquisition of image data is completed and the image forming operation is feasible.

Further, for notification of information that the image forming operation is ongoing, for example, the control board 57 blinks the LED lamp 14a of the print button 14 in blue when the print button 14 is pressed in a state where the image forming operation is feasible.

Further, for notification of information that the image forming operation has completed, for example, the control board 57 turns off the LED lamp 14a of the print button 14 when the image forming operation has completed.

As described above, in the present embodiment, the handheld printer 10 uses the LED lamp 14a of the print button 14 to notify the user of information about the printer body 1 when the user is holding the printer body 1, not the LED lamp 15a of the power button 15. With this configuration, even though simple, the printer body 1 can perform such information notification for the user, even in the arrangement in which the power button 15 is disposed at a position hidden by the palm of the user to prevent the erroneous operation of the power button 15.

The LED lamp 15a of the power button 15 in the present embodiment is mainly used for notification of the charge state of the battery 51. For example, in a state where the USB cable is connected to the USB connection port 6 and the battery 51 can be charged by an external power source, the control board 57 causes the LED lamp 15a of the power button 15 to keep emitting green light during the charging and turns off the LED lamp 15a of the power button 15 when charging is completed.

On the other hand, in a period in which the battery 51 is not charged, the control board 57 causes the LED lamp 15a of the power button 15 to keep emitting blue light when the charge amount of the battery 51 is equal to or greater than 50%. When the charge amount of the battery 51 is equal to or greater than 20% and less than 50%, the control board 57 blinks the LED lamp 15a of the power button 15 in blue. When the charge amount of the battery 51 is less than 20%, the control board 57 blinks the LED lamp 15a of the power button 15 in red. Further, when the battery is in a depleted state, the control board 57 causes the LED lamp 15a of the power button 15 to keep emitting red light.

In addition, when the printer body 1 has an error during idle time in which image formation is not performed, for such a notification, for example, the control board 57 causes the LED lamp 14a of the print button 14 and the LED lamp 15a of the power button 15 to keep emitting red light. Further, when the printer body 1 is in an error state in the image forming operation, the control board 57 notifies the user of the error state, for example, as follows.

When the user moves the printer body 1 (manual scanning) at a speed exceeding the upper limit, the control board 57 blinks the LED lamp 14a of the print button 14 in red for the notification of the error state while controlling the LED lamp 15a of the power button 15 according to the charge amount.

Embodiment 2 Descriptions are given below of another embodiment (hereinafter “Embodiment 2”) in which aspects of the present disclosure are applied to a handheld printer as a mobile image forming apparatus similar to Embodiment 1 described above.

In above-described Embodiment 1, erroneous operation of the power button 15 disposed, similar to the print button 14, on the upper side 31 is inhibited with the arrangement of the power button 15. By contrast, in the printer body 1 according to Embodiment 2, erroneous operation of the power button 15 is inhibited with operation control of the power button 15.

Note that the printer body 1 according to Embodiment 2 has a hardware configuration similar to that in Embodiment 1 described above. Thus, redundant descriptions are omitted, and differences from the above-described Embodiment 1 will be mainly described in the following.

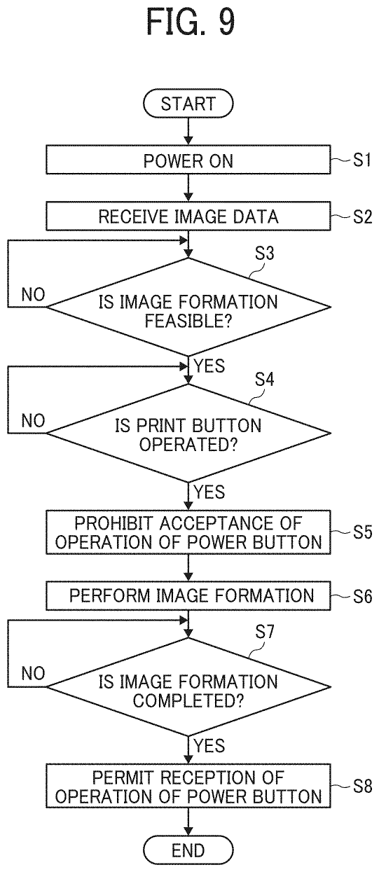

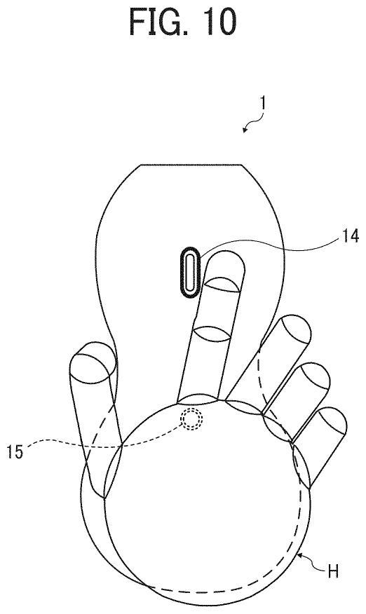

FIG. 9 is a flowchart illustrating an operation flow to control the power button 15 according to Embodiment 2.

When the power button 15 is pressed, the printer body 1 is powered on (S1). On the control board 57, the CPU 55 initiates startup according to the program stored in the ROM 54 and loads the program and each data in the RAM 53. In S2, the BT board 52 receive image data from an external device by short-range wireless communication. In S3, the control board 57 determines whether an image forming operation is feasible. When image formation is feasible (Yes in S3), the control board 57 changes the state of the LED lamp 14a of the print button 14 from a blue light blinking state to a blue continuous lighting state as described above.

In Embodiment 2, after the handheld printer 10 becomes ready for an image forming operation, the control board 57 determines whether the user has operated the print button 14. In response to a determination that the user has operated the print button 14 (Yes in S4), the control board 57 prohibits acceptance of an operation signal from the power button 15 (S5). As described above, in the period in which the reception of the operation signal from the power button 15 is prohibited, even if the power button 15 is operated, either the operation signal is not input to the control board 57 or the control board 57 does not perform the operation or processing according to such an operation signal. At S6, the control board 57 starts the image forming operation. According to the image data received, the recording controller 56 generates a drive waveform to control the discharge of ink from the inkjet head 40 in order to form an image corresponding to the position on the surface of the recording medium detected by the position sensor 59.

At S7, the control board 57 determines whether the image forming operation has completed. In response to a determination that image formation has completed (Yes in S7), the control board 57 permits reception of the operation signal from the power button 15 (S8). Then, the power can be turned off in response to the operation of the power button 15.

According to the present embodiment, in the image forming operation period from the start of the image forming operation to the end of the image forming operation, there is a prohibition period in which the operation to turn off the power input from the power button 15 is prohibited. Therefore, even if the user operates the power button 15 in the prohibition period in the image forming operation, the power is not turned off, and unintentional termination of the ongoing image forming operation can be inhibited. The prohibition period may be a part or entire of the image forming operation period.

Note that, although an example structure in which the print button 14 and the power button 15 on the upper side 31 are arranged similar to Embodiment 1 is described above as Embodiment 2, the limitation on the arrangement of the power button 15 according to Embodiment 1 is not imposed on Embodiment 2. Therefore, for example, the power button 15 may be disposed at such a position on the upper side 31 that the power button 15 is not hidden by the palm of the user when the user holds the printer body 1 in the regular posture. In this case, even when the user holds the printer body 1 in the regular posture, the handheld printer 10 can notify the user of information using both the LED lamps 14a and 15a of the print button 14 and the power button 15. Therefore, even having a simple structure, the printer body 1 can indicate a greater amount of information than that in Embodiment 1 described above.

Although descriptions have been made of the examples in which aspects of the present disclosure are applied to the inkjet handheld printer 10 as Embodiments 1 and 2, the aspects of the present disclosure can also be applied to other types of image forming apparatuses. The aspects of the present disclosure can be applied to a recording apparatus of, for example, thermal type or thermal-transfer type. A printer body of a thermal-transfer type recording apparatus includes an ink ribbon as a container for storing liquid. Accordingly, a recess can be formed at the bottom of the ink ribbon, and a position sensor to detect the recording medium can be disposed in a space formed by the recess.

Embodiments 1 and 2 concern examples in which the operation input device is the print button 14 being a button to be pressed, to input an image formation instruction. However, the operation input device can have any structure to mechanically switch on and off, such as a slide structure. In addition, instead of a mechanically switching operation device, an operation device of electrically switching type, such as a touch panel, can be used.

Embodiments 1 and 2 concern an example in which the power operation device is the power button 15 being a button to be pressed. However, the operation device can have any structure to mechanically switch on and off, such as a slide structure.

Embodiment 1 and Embodiment 2 concern examples in which the upper side 31 of the printer body 1 serving as the operation face has an outer shape that is like a long rectangle, but the shape is not limited to rectangles as long as being long in a predetermined direction. For example, the shape can be an elliptical shape or a gourd shape as illustrated in FIG. 10 (having a contour narrowed in a longitudinal middle portion).

The structures described above are examples, and aspects of the present disclosure provide respective effects as follows. Aspect 1

According to Aspect 1, a mobile image forming apparatus (for example, the handheld printer 10) includes a recording side (e.g., the recording side 30) to be disposed opposite a recording medium (e.g., the recording medium P) and an operation face (e.g., upper side 31) opposite the recording side, and a power operation device (e.g., the power button 15) and an operation input device (e.g., the print button 14) are disposed on the operation face. Specifically, on the operation face, the operation input device is disposed at a first position shifted from a center position in a predetermined direction of the operation face, and the power operation device is disposed at a second position on an opposite side of the first position with respect to the center position.

Generally, in a mobile image forming apparatus in which the operation input device is disposed on the operation face opposite the recording side facing the recording medium, the user holds the mobile image forming apparatus with one hand, taking a posture to be able to operate, with the forefinger or the middle finger, the operation input device on the operation face and moves the apparatus (manual scanning) for image formation. At this time, if the power operation device is disposed near the operation input device on the same operation face as the operation input device, there is a risk that the user touches the power operation device with the finger in the image forming operation. Then, the power of the apparatus may be accidentally turned off, and the image forming operation may be terminated halfway.

According to this aspect, the operation input device is disposed at the first position shifted in the predetermined direction from the center position on the operation face, and the power operation device is disposed at the second position located on the opposite side of the first position with respect to the center position on the operation face. With such an arrangement, when the user holds the image forming apparatus taking the above-described posture, the power operation device is positioned closer to the wrist of the user than the area accessible with a finger of the hand holding the image forming apparatus. With such placement, the finger of the holding hand does not touch the power operation device, and the power operation device is not erroneously operated by the finger of the user during the image forming operation. Accordingly, termination of the ongoing image forming operation can be inhibited.

Aspect 2

According to Aspect 2, in Aspect 1, an image forming device (for example, the recording portion of the inkjet head 40) configured to form an image on the recording medium is shifted from the center on the recording side in the predetermined direction.

According to this, since the image forming device is shifted in the same direction as the operation input device, an image is formed at a position below the forefinger or the middle finger when the user holds and manually moves the apparatus with one hand, in the posture to be able to operate the operation input device on the operation face with the forefinger or the middle finger. In this case, the position of image formation is not hidden by the palm of the user, and the user can view the position of image formation.

Aspect 3

According to Aspect 3, in Aspect 1 or 2, the operation face has a long shape, and the predetermined direction is a longitudinal direction of the operation face.

According to this aspect, in the longitudinal direction of the long operation face, the operation input device is disposed on one side of the operation face, and the power operation device is disposed on the other side of the operation face. The long shape of the operation face can limit conceivable positions of the hand of the user gripping the apparatus. As a result, when the user grips the apparatus to be able to operate the operation input device on the operation face with the forefinger or the middle finger, variations in the gripping positions of the users can be reduced. As a result, for most of the users, when the user holds the image forming apparatus in the above-described posture, the power operation device is positioned closer to the wrist than the area accessible by the finger of the user holding hand. With such placement, the finger of the holding hand does not touch the power operation device, and the power operation device is not erroneously operated by the finger of the user during the image forming operation. Accordingly, termination of the ongoing image forming operation can be inhibited.

Aspect 4

According to Aspect 4, in any one of Aspects 1 to 3, the predetermined direction is a direction orthogonal to a scanning direction in image formation.

In this aspect, in the direction orthogonal to the scanning direction in which the user moves the apparatus for image formation, the operation input device is disposed on one side on the operation face and the power operation device is on the other side on the operation face. Designating the scanning direction can limit conceivable positions of the hand of the user gripping the apparatus. As a result, when the user grips the apparatus to be able to operate, with the forefinger or the middle finger, the operation input device on the operation face, variations in the gripping positions of the users can be reduced. As a result, for most of the users, when the user holds the image forming apparatus in the above-described posture, the power operation device is positioned closer to the wrist than the area accessible by the finger of the user holding hand. With such placement, the finger of the holding hand does not touch the power operation device, and the power operation device is not erroneously operated by the finger of the user during the image forming operation. Accordingly, termination of the ongoing image forming operation can be inhibited.

Aspect 5

According to Aspect 5, in any one of Aspects 1 to 4, the power operation device is disposed in a wrist-side region of the operation face (e.g., the upper side 31) facing a portion of the hand of the user closer to a wrist side than a second joint (e.g., H22 or H32 in FIG. 8) of the forefinger (e.g., H2 in FIG. 8) or the middle finger (e.g., H3 in FIG. 8) when the user holds with one hand the mobile image forming apparatus in a posture in which the operation input device can be operated by the forefinger or the middle finger.

When the user grips the apparatus with one hand, generally, the forefinger H2 or the middle finger H3 of the gripping hand does not touch the region of the operation face opposed by the portion of the gripping hand closer to the wrist than the second joint H22 of the forefinger H2 or the second joint or H32 of the middle finger H3 thereof. In this aspect, since the power operation device (e.g., the power button 15) is located in such a region, the power operation device is not erroneously operated by the finger of the user during the image forming operation. Accordingly, this configuration can inhibit an accidental termination of the image forming operation.

Aspect 6

According to Aspect 6, the mobile image forming apparatus according to any one of Aspects 1 to 5 includes at least one of a first finger rest portion (e.g., the first finger-grip portion 38A) disposed on a first lateral face (e.g., the left side 32) of the body of the mobile image forming apparatus and a second finger rest portion (e.g., the second finger-grip portion 38B) disposed on a second lateral face (e.g., the right side 33) of the body opposite the first lateral face. When the user holds the body with one hand in a posture to operate the operation input device with the forefinger (H2 in FIG. 8) or the middle finger (H3 in FIG. 8), the first finger rest portion is to be held by the thumb (H1 in FIG. 8) of the hand of the user, and the second finger rest portion is to be held by the middle finger, the ring finger, or the little finger of that hand. Further, the operation input device is disposed, on the operation face, closer to the fingertip side end of the body than the fingertip side end (e.g., G1 in FIG. 8) of the first finger rest portion or the second finger rest portion, and the power operation device is disposed, on the operation face, closer to the wrist side end of the body than the fingertip side end G1 of the first finger rest portion or the second finger rest portion.

In this aspect, since at least one of the first finger rest portion and the second finger rest portion is provided, possible postures of the user for gripping the apparatus are limited. As a result, when the user grips the apparatus in the posture to operate the operation input device located on the operation face with the forefinger or the middle finger, variations in the gripping positions of the users can be reduced. In such arrangement, further, the operation input device is disposed, on the operation face, closer to the fingertip side than the fingertip side end G1 of the finger rest portion, and the power operation device is disposed, on the operation face, closer to the wrist than the fingertip side end G1 of the finger rest portion. As a result, for most of the users, when the user holds the image forming apparatus in the above-described posture, the power operation device is positioned closer to the wrist than the area accessible by the finger of the user holding hand. With such placement, the finger of the holding hand does not touch the power operation device, and the power operation device is not erroneously operated by the finger of the user during the image forming operation. Accordingly, termination of the ongoing image forming operation can be inhibited.

Aspect 7

According to Aspect 7, in any one of Aspects 1 to 7, a dimension of the power operation device is smaller than a dimension of the operation input device.

According to this, for the user, touching the power operation device is less easy than touching the operation input device, and erroneous operation of the power operation device during the image forming operation can be inhibited.

Aspect 8

According to Aspect 8, the mobile image forming apparatus according to any one of Aspects 1 to 7 further includes a light-emitting element (for example, the LED lamp 14a) to illuminate the operation input device, and circuitry (for example, the control board 57) configured to control the light emission state of the light-emitting element.

With the above-described arrangement, when the user grips the image forming apparatus, the power operation device may be hidden behind the palm of the user and not visible. In this case, it is desirable to use the light-emitting element of the operation input device, instead of the light-emitting element of the power operation device, in order to perform notification of information to the user when the user grips the apparatus. According to this aspect, the light emission state of the light-emitting element to illuminate the operation input device is controllable. Accordingly, the notification of information to the user can be made using the light emission sate of the light-emitting element of the operation input device even when the power operation device is hidden behind the palm of the hand of the user.

Aspect 9

According to Aspect 9, a mobile image forming apparatus (for example, the handheld printer 10) includes a recording side (e.g., the recording side 30) to be disposed opposite a recording medium (e.g., the recording medium P) and an operation face (e.g., upper side 31) opposite the recording side, and a power operation device (e.g., the power button 15) and an operation input device (e.g., the print button 14) are disposed on the operation face. The mobile image forming apparatus further includes circuitry configured to provide a prohibition period in which an operation to turn off power input from the power operation device (e.g., the power button 15) is prohibited, in a period from the start of the image forming operation instructed via the operation input device until the end of the image forming operation.

In this aspect, in the period from the start of the image forming operation to the end of the image forming operation, there is a prohibited period in which the operation of turning off the power is prohibited even if the power operation device is operated. Therefore, even if the user operates the power operation device in the prohibition period in the image forming operation, the power is not turned off, and unintentional termination of the ongoing image forming operation can be inhibited.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming apparatus comprising:
a body including:
a recording side to be disposed opposite a recording medium; and
an operation face opposite the recording side;
an image forming device supported on the recording side and configured to form an image on the recording medium;
an operation input device configured to input an image formation instruction and disposed at a first position on the operation face, the first position shifted from a center position on the operation face in a predetermined direction; and
a power operation device configured to power on and off the image forming apparatus and disposed at a second position on the operation face, the second position located on an opposite side of the first position with respect to the center position on the operation face.

2. The image forming apparatus according to claim 1,
wherein the image forming device is disposed at a position shifted from a center position on the recording side in the predetermined direction.

3. The image forming apparatus according to claim 1,
wherein the predetermined direction is a longitudinal direction of the operation face.

4. The image forming apparatus according to claim 1,
wherein the predetermined direction is orthogonal to a scanning direction in which the image forming apparatus is to be moved in image formation.

5. The image forming apparatus according to claim 1,
wherein the power operation device is disposed in a wrist-side region of the operation face to face a portion of a hand of a user holding the image forming apparatus, the wrist-side region being closer to a wrist of the user than a second joint of one of a forefinger and a middle finger of the hand holding the body in a posture to operate the operation input device with the one of the forefinger and the middle finger.

6. The image forming apparatus according to claim 1, further comprising at least one of:
a first finger rest portion disposed on a first lateral face of the body to be held by a thumb of a hand of a user holding the body in a posture to operate the operation input device with one of a forefinger and a middle finger of the hand; and
a second finger rest portion disposed on a second lateral face of the body opposite the first lateral face, the second finger rest portion to be held by one of the middle finger, a ring finger, and a little finger of the hand,
wherein the operation input device is disposed, on the operation face, closer to a fingertip side end of the body than a fingertip side end of the first finger rest portion or the second finger rest portion, and
wherein the power operation device is disposed, on the operation face, closer to a wrist side end of the body than the fingertip side end of the first finger rest portion or the second finger rest portion.

7. The image forming apparatus according to claim 1,
wherein a dimension of the power operation device is smaller than a dimension of the operation input device.

8. The image forming apparatus according to claim 1, further comprising:
a light-emitting element configured to illuminate the operation input device; and
circuitry configured to control a light emission state of the light-emitting element.

9. An image forming apparatus comprising:
a body including:
a recording side to be disposed opposite a recording medium; and
an operation face opposite the recording side;
an image forming device supported on the recording side and configured to form an image on the recording medium;
a power operation device disposed on the operation face and configured to power on and off the image forming apparatus;
an operation input device disposed on the operation face and configured to input an image formation instruction; and
circuitry configured to provide a prohibition period in a period from a start of an image forming operation by the image forming device to an end of the image forming operation, the prohibition period in which the circuitry prohibits powering off the image forming apparatus in response to an operation of the power operation device.
